(19) United States
(12) Patent Application Publication
(10) Pub. No.: US 2009/0100975 A1
(43) Pub. Date: Apr. 23, 2009

(54) Rotary cutter, and anvil roll for rotary cutting apparatus

(75) Inventors: Gilbert Grenier, Annonay (FR); Jacques Secondi, Tournon-Sur-Rhone (FR); Lillian Monteil, Saint Martin D'Aout (FR)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 12/289,503

(22) Filed: Oct. 29, 2008

Related U.S. Application Data
(62) Division of application No. 11/166,375, filed on Jun. 27, 2005.

(30) Foreign Application Priority Data
Jul. 2, 2004 (SE) 0401732-3

(51) Int. Cl. B26D 1/34; B26D 7/00

(52) U.S. Cl. 83/347; 83/701

(57) ABSTRACT

A rotary cutting apparatus includes a rotary cutter and a cooperating anvil roll, each including a center arbour, a peripheral sleeve, and an intermediate sleeve disposed radially between the peripheral sleeve and the arbour. The intermediate sleeve of either the rotary cutter on the anvil roll, or both can be formed of a material for vibration damping, thermal insulation, thermal conduction, weight increase and/or weight reduction.

The present application is a Divisional of copending application Ser. No. 11/166,375, filed Jun. 27, 2005, which claims priority to Sweden Application No. 0401732-3 filed Jul. 2, 2004.

### TECHNICAL BACKGROUND OF THE INVENTION

The present invention relates to a rotary cutter for a rotary cutting apparatus comprising an arbour and a peripheral sleeve, said peripheral sleeve being provided with at least one cutting member adapted to be in cutting relationship with an anvil roll. The invention also relates to an anvil roll and a rotary cutting apparatus provided with such a rotary cutter, and to the anvil roll per se. The invention also relates to manufacturing methods.

Such a rotary cutting apparatus provided with such a rotary cutter and such an anvil roll is known from U.S. Pat. No. 4,770,078, which discloses a rotary cutter and an anvil, each provided with a sleeve arranged on an arbour, respectively, the sleeve being connected to the arbour by pneumatic pressure.

In U.S. Pat. No. 4,073,208 a cutter roll is disclosed and is provided with cutting knives adapted to co-operate with an anvil roll having a resilient die blanket arranged on a slip ring, constituting the intermediate layer. The slip ring is intended avoid deformation of the die blanket.

An alternative solution regarding slip rings in a rotary cutting apparatus is disclosed in U.S. Pat. No. 4,982,639.

GB-A 2,035,876 discloses the provision of a segmented intermediate layer for facilitating mounting of thereof on the rotary cutter and the anvil. The purpose is to allow adjustment of the size of the rotary cutter and the anvil roll.

U.S. Pat. No. 4,848,204 discloses a replaceable cover for an anvil roll. The cover is resilient and arranged on a liner of steel.

Also U.S. Pat. No. 3,731,600 discloses the provision of a resilient surface on the anvil.

### SUMMARY OF THE INVENTION

An object of the present invention is to improve the stability of a rotary cutter and anvil.

This has been achieved by a rotary cutter, an anvil and a rotary cutting apparatus as initially defined, respectively, wherein an intermediate sleeve is arranged between the arbour and the peripheral sleeve. Hereby, the cutting properties are improved.

Preferably, the intermediate sleeve is made of a stability improving material. Hereby are achieved more steady cutting conditions.

Suitably, the intermediate sleeve is made of a vibration damping material. In particular, the vibration damping material is a polymer or rubber based material, a tungsten based alloy or a mineral based material. Hereby are achieved that the cutting force is stabilized and the cutting is less disturbed by vibrations coming e.g. from ball bearings or a coupling.

In addition, or alternatively, the intermediate sleeve is made of a thermally insulating material. In particular, the thermally insulating material is a polymer or rubber based material, a mineral based material or a non-conducting metal. Hereby is achieved that heat generated by friction e.g. in ball bearings or an air distributor does not reach the sides the rotary cutter or the anvil. This ensures a greater dimensional stability.

Alternatively, the intermediate sleeve is made of a thermally conducting material. In particular, the thermally conducting material is a conducting metal or alloy and/or a polymer or rubber based material loaded with conducting particles. Hereby is achieved that the heat is effectively diffused in a homogenous way on the whole peripheral sleeve of the rotary cutter or the anvil. Thus, the radial thermal expansion of the entire axial extension of the sleeve is equalised and the cutting function is improved and stabilized.

In addition, or alternatively, the intermediate sleeve is made of a light-weight material. In particular, the light-weight material is a light metal or a polymer or rubber based material with or without a load limited in mass. Hereby is achieved that inertia of the rotary cutter and the anvil is allowed to be reduced. This limits the risk for relative sliding to occur between the rotary cutter and the anvil when rotational speed is changed, e.g., in response to acceleration or deceleration during starts and stops.

Alternatively, the intermediate sleeve is made of a heavy material. In particular, the heavy material is a heavy metal, a polymer or rubber based material with a heavy mass, or a mineral based material. Hereby it is possible to avoid a condition wherein the rotary cutting apparatus works at its natural frequency. Furthermore, the cutting operation is stabilized in the sense that it is less easily affected by external disturbances.

Preferably, said arbour is made of steel.

According to the invention, the rotary cutter can be made by radially spacing the peripheral sleeve from the arbour in a mold while in coaxial relationship and pouring polymer or rubber into the annular space formed therebetween. The anvil roll could be similarly made.

Alternatively, the intermediate sleeve and the peripheral sleeves are arranged on the arbour by shrink fit or press fit.

Alternatively, the intermediate sleeve and the peripheral sleeves are arranged on the arbour by gluing or screwing.

### DRAWING SUMMARY

In the following, preferred embodiments of the invention will be described in further detail with reference to the accompanying drawings, in which

FIG. 1 illustrates schematically a first embodiment of a rotary cutting apparatus according to the invention, with a rotary cutter and an anvil roll depicted in longitudinal section.

FIG. 1A is an enlarged fragmentary view of an encircled portion of FIG. 1.

FIG. 2 illustrates schematically a second embodiment of a rotary cutting apparatus according to the invention, with the rotary cutter and anvil being provided with radial air openings, disposed inside and outside of the cutting member, with the air openings disposed inside the cutter being depicted.

FIG. 3 illustrates schematically the second embodiment of the rotary cutting apparatus, with the radial air openings located outside of the cutting member being depicted, and with an optional fastener being shown.

### DETAILED DESCRIPTION OF PREFERRED EMBODIMENTS

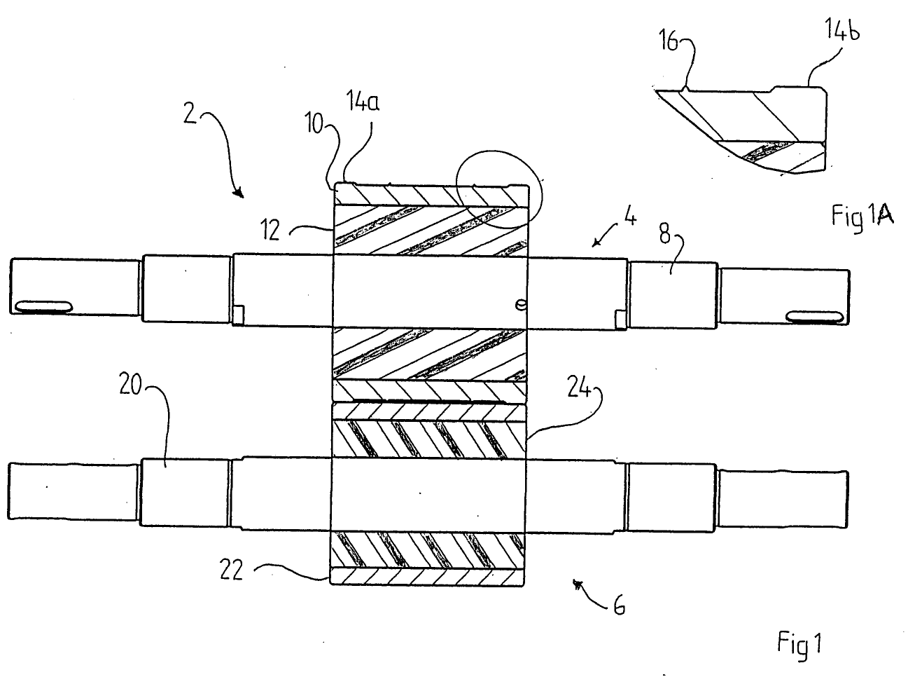

FIG. 1 shows a rotary cutting apparatus 2 comprising a rotary cutter 4 and an anvil roll 6. The rotary cutter 4 has an arbour 8 made of steel, a peripheral sleeve 10 made of a cemented carbide, and an intermediate sleeve 12. The peripheral sleeve is provided with a pair of annular abutment members 14a, 14b and a cutting member 16. The anvil roll 6 has an arbour 20 made of steel, a peripheral sleeve 22, and an intermediate sleeve 24. The peripheral sleeves 10, 22 may be made of a multiphase material, such as steel, cemented carbide or cermet (a hard phase bonded by a metal).

The intermediate sleeve 12/24 is secured to both the peripheral sleeve 10/22 and the arbour 8/20 for rotation therewith. The intermediate sleeve 12/24 extends substantially the entire axial extent of the peripheral sleeve 10/22, whereby no contact occurs between the peripheral sleeve 10/22 and the arbour 8/20.

According to the invention, the material of the intermediate sleeves 12 and 24 is chosen depending on the desired properties, such as stabilization, vibration damping, thermal insulation, thermal conduction, and weight increase or weight reduction.

### Vibration Damping

The vibration damping material of the intermediate sleeves 12 and/or 24 may be polymer based and/or rubber based and may contain inorganic particles such as a metal powder or crushed mineral particles. In particular, the vibration damping material is a polymer or rubber based material, a tungsten based alloy or a mineral based material. Hereby are achieved that the cutting force is stabilized and the cutting is less disturbed by vibrations coming e.g. from ball bearings or a coupling.

### Thermal Insulation

The thermal insulation material of the intermediate sleeves 12 and/or 24 may likewise be polymer based, rubber based and/or mineral based. In addition, or alternatively, a non-conducting metal, such as stainless steel may be utilised. Hereby is achieved that heat generated by friction e.g. in ball bearings or an air distributor does not reach the sides the rotary cutter or the anvil. This ensures a greater dimensional stability.

### Thermal Conduction

For improved thermal conduction, a conductive material such as magnesium, Al, Cu, Iron-based alloys, and/or a polymer based materials containing inorganic particles, such as a metal powder may be used to form the intermediate sleeves 12 and/or 24. Hereby is achieved that the heat is effectively diffused in a homogenous way on the whole peripheral sleeve of the rotary cutter or the anvil. Thus, the radial thermal expansion of the entire axial extension of the sleeve is equalised and the cutting function is improved and stabilized.

### Weight Reduction

For reducing the weight of the rotary cutter and the anvil roll, the intermediate sleeve 12 and/or 24 may be made of a metal having a low density, such as Mg or Al. Alternatively or in combination; it may be made based on a polymer or rubber with a low weight mass or no mass at all. Hereby is achieved that inertia of the rotary cutter and the anvil is allowed to be reduced. This limits the risk for relative sliding to occur between the rotary cutter and the anvil when rotational speed is changed, e.g., in response to acceleration or deceleration during starts and stops.

### Weight Increase

For increasing the weight of the rotary cutter and the anvil roll, the intermediate sleeve 12 and/or 24 may be made of a metal of high density, such as Pb, Cu, Co or Ni. Alternatively or in combination, it may be polymer based and/or rubber based loaded with a heavy mass. It may instead or in combination be based on a mineral. Hereby it is possible to avoid a condition wherein the rotary cutting apparatus works at its natural frequency. Furthermore, the cutting operation is stabilized in the sense that it is less easily affected by external disturbances.

### Combination of Properties

Depending on the choice of material, it is thus possible to achieve an intermediate layer that has one or more of the above properties, i.e. stabilization; vibration damping; thermal insulation or thermal conduction; and/or weight increase or weight reduction.

It should be noted that it is possible to choose different properties of the anvil roll and the rotary cutter, respectively.

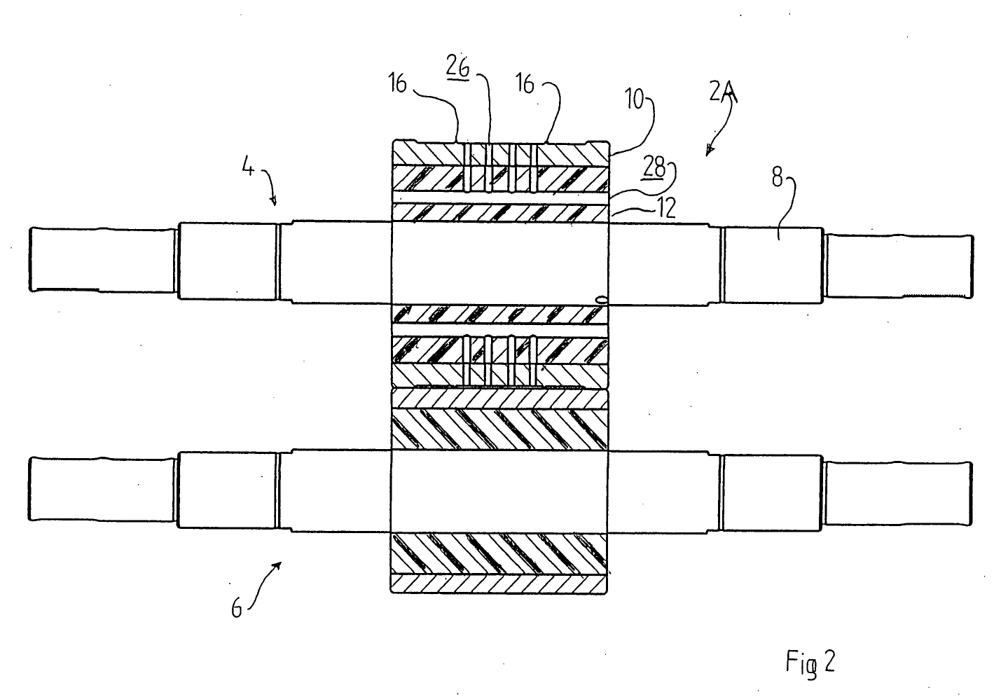

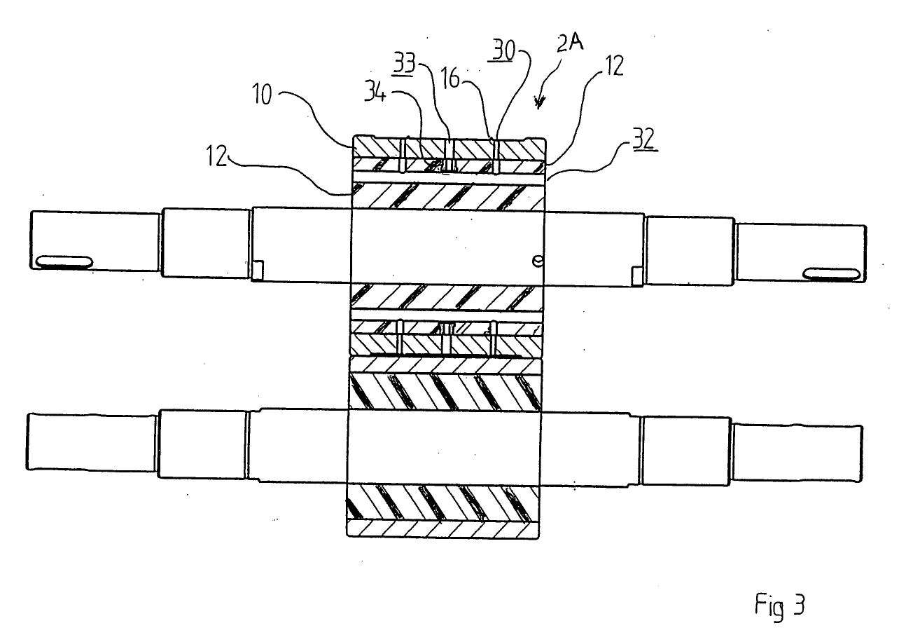

FIGS. 2 and 3 show a rotary cutting apparatus 2A of the same kind as the one shown in FIG. 1, however with radial through-holes 26 and 30 being provided. The through-holes 26 are located inside the cutting members 16 and extend through the peripheral sleeve and partially through the intermediate sleeve to an axial lumen 28 in the intermediate sleeve connected to a not-shown pressure source. Furthermore, axially outside the cutting members 16, radial holes 30 extending through the peripheral sleeve and partially through the intermediate sleeve are connected to an axial bore 32 (see FIG. 3) in the intermediate sleeve. It will be appreciated that the longitudinal sections shown in FIGS. 2 and 3, respectively, are taken at circumferentially spaced locations of the anvil roll.

FIG. 3 also shows the rotary cutting apparatus 2A, however with an optional opening 33 and nut 34 depicted for allowing an insert to be screwed onto the surface of the rotary cutter.

When cutting a web, the through-holes 26 and the holes 30 are subjected to vacuum before the cutting member 16 cuts the web. After the cutting operation, the through-holes 26 are subjected to over-pressure or atmospheric pressure in order to allow the cut article to be released from the rotary cutter. The vacuum in holes 30 is however maintained in order to allow the web to rotate together with the rotary cutter such that the web can be collected at a position other than that of the cut articles.

Of course, the choice of properties of the intermediate layer described in connection with FIG. 1 also relates to the embodiment of FIGS. 2 and 3.

The rotary cutter and/or the anvil roll may be produced by maintaining the peripheral sleeve and the arbour in a desired coaxial, radially spaced relationship in a mold such that an annular space is created between the peripheral sleeve and the arbour, and a polymer or rubber is poured into the space. Upon hardening, the polymer or rubber forms the intermediate sleeve.

Alternatively, a pre-formed intermediate sleeve and peripheral sleeve are arranged on the arbour by shrink fit or press fit. Alternatively, the intermediate sleeve and the peripheral sleeve are arranged on the arbour by gluing or screwing.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. A rotary cutter adapted to cooperate with an anvil roll of a rotary cutting apparatus, the rotary cutter comprising an arbour, a peripheral sleeve provided with at least one cutting member, and an intermediate sleeve arranged radially between the arbour and the peripheral sleeve.

2-6. (canceled)

7. The rotary cutter according to claim 1, wherein the intermediate sleeve comprises a thermally conductive material.

8. The rotary cutter according to claim 7, wherein the thermally conductive material comprises one of a thermal conducting metal, a thermal conducting alloy, a thermal conducting polymer based material or a thermal conducting rubber based material, the thermally conducting material being loaded with conducting particles.

9-57. (canceled)
